(19) United States
(12) Patent Application Publication
(10) Pub. No.: US 2024/0328992 A1
(43) Pub. Date: Oct. 3, 2024

(54) SENSOR ELEMENT

(71) Applicant: NGK INSULATORS, LTD., Nagoya-shi (JP)

(72) Inventors: Katsuya YOSHIDA, Fusou-cho (JP); Ryo HAYASE, Nagoya-shi (JP); Takamasa MATSUBARA, Komaki-shi (JP)

(21) Appl. No.: 18/602,459

(22) Filed: Mar. 12, 2024

(30) Foreign Application Priority Data
Mar. 27, 2023 (JP) 2023-050490

(51) Int. Cl. G01N 27/407

(52) U.S. Cl. CPC G01N 27/4077; G01N 27/4071; G01N 27/4073

(57) ABSTRACT

A sensor element includes: an element body that includes a base part in an elongated plate shape, and a measurement-object gas flow cavity; and a porous protective layer that is formed from one end in the longitudinal direction of the base part and covers a surface of a predetermined length in the longitudinal direction of the element body. The element body includes an extracavity electrode on one principal surface of the element body. The protective layer includes an inner layer and an outer layer; and has an electrode presence region and a posterior region following to the electrode presence region in the longitudinal direction. A porosity in the posterior region of the inner layer is lower than a porosity in the electrode presence region of the inner layer, and a porosity of the outer layer is lower than the porosity in the posterior region of the inner layer.

### CROSS-REFERENCE TO RELATED APPLICATION

The present application claims priority from Japanese application JP2023-050490, filed on Mar. 27, 2023, the contents of which is hereby incorporated by reference into this application.

### BACKGROUND OF THE INVENTION

### Technical Field of the Invention

The present invention relates to a sensor element for detecting a target gas to be measured in a measurement-object gas.

### Background Art

A gas sensor is used for detection or measurement of concentration of an objective gas component (oxygen O₂, nitrogen oxide NOx, ammonia NH₃, hydrocarbon HC, carbon dioxide CO₂, etc.) in a measurement-object gas, such as exhaust gas of automobile. As such a gas sensor, a gas sensor which has a sensor element using an oxygen ion conductive solid electrolyte such as zirconia (ZrO₂) is known.

It is known that in such a gas sensor, a porous protective layer is formed on the surface of the sensor element for the purpose of preventing the occurrence of cracking in the internal structure of the sensor element due to thermal shock resulting from the attachment of moisture to the sensor element. That is, a sensor element provided with an element body and a porous protective layer covering the element body is known. For example, JP 2014-098590 A and WO 2020/203029 A1 disclose a multi-layered protective layer, and disclose that the protective layer includes an inside layer and an outside layer having a lower porosity than that of the inside layer.

### CITATION LIST

### Patent Documents

Patent Document 1: JP 2014-098590 A
Patent Document 2: WO 2020/203029 A1

### SUMMARY OF THE INVENTION

### Problems to be Solved by the Invention

The sensor element has a high temperature (e.g., about 800° C.) when the gas sensor performs measurement of a target gas to be measured. There is a problem that when moisture attaches to such a sensor element having a high temperature, cracking occurs in an internal structure of the sensor element due to the thermal shock.

In a protective layer including an inside layer (inner layer) and an outside layer (outer layer) having a lower porosity than that of the inner layer (for example, the protective layer disclosed in the above-mentioned JP 2014-098590 A and WO 2020/203029 A1), a higher porosity of the inner layer improves heat insulation performance of the protective layer. As a result, the occurrence of cracking in the internal structure of the sensor element due to exposure to water (water splash) can be better suppressed. That is, the water resistance of the sensor element can be improved.

However, it is concerned that the higher the porosity of the inner layer in the protective layer, the lower the adhesion strength between the element body and the inner layer.

It is therefore an object of the present invention to provide a sensor element that has high water resistance while the adhesion strength between the element body and the protective layer is maintained.

### Means for Solving the Problems

The present inventors have intensively studied and found that high water resistance can be maintained while the adhesion strength between the element body and the protective layer is maintained by making, in a porous protective layer covering at least a part of a surface of the element body in the longitudinal direction, a porosity of a posterior region in an inner layer of the protective layer lower than a porosity of a region in which the extracavity electrode exists (a roughly center region in the inner layer in the longitudinal direction of the element body).

The present invention includes the following aspects.

(1) A sensor element for detecting a target gas to be measured in a measurement-object gas, the sensor element comprising:

an element body that includes a base part in an elongated plate shape, including an oxygen-ion-conductive solid electrolyte layer, and a measurement-object gas flow cavity formed on a side of one end in a longitudinal direction of the base part; and

a porous protective layer that is formed from the one end in the longitudinal direction of the base part and covers a surface of a predetermined length in the longitudinal direction of the element body, wherein

the element body comprises: an intracavity electrode disposed in the measurement-object gas flow cavity; and an extracavity electrode that has a predetermined length in the longitudinal direction of the base part, is disposed on one principal surface of two principal surfaces of the element body, and corresponds to the intracavity electrode; and

the protective layer comprises an inner layer covering the element body and an outer layer positioned outside the inner layer; and has an electrode presence region in which the extracavity electrode exists and a posterior region following to the electrode presence region in the longitudinal direction of the base part; and wherein

a porosity in the posterior region of the inner layer is lower than a porosity in the electrode presence region of the inner layer, and

a porosity of the outer layer is lower than the porosity in the posterior region of the inner layer.

(2) The sensor element according to the above (1), wherein the posterior region of the protective layer extends in the longitudinal direction of the base part to a position farther from the one end in the longitudinal direction of the base part than the measurement-object gas flow cavity.

(3) The sensor element according to the above (2), wherein, in the longitudinal direction of the base part, a porosity in a region farther from the one end in the longitudinal direction of the base part than the measurement-object gas flow cavity in the posterior region of the protective layer is lower than the porosity in the electrode presence region of the inner layer.

That is, in the above (3), a porosity in a most posterior region farther from the one end in the longitudinal direction of the base part than the measurement-object gas flow cavity in the posterior region is lower than the porosity in the electrode presence region of the inner layer.

(4) The sensor element according to any one of the above (1) to (3), wherein the porosity in the posterior region of the inner layer is 30% by volume or more and 50% by volume or less.

(5) The sensor element according to any one of the above (1) to (4), wherein the porosity in the electrode presence region of the inner layer is 40% by volume or more and 80% by volume or less, provided that the porosity in the electrode presence region of the inner layer is higher than the porosity in the posterior region of the inner layer.

(6) The sensor element according to any one of the above (1) to (5), wherein the porosity in the posterior region of the inner layer is lower than the porosity in the electrode presence region of the inner layer by 5% by volume or more.

(7) The sensor element according to any one of the above (1) to (6), wherein the posterior region of the protective layer extends in the longitudinal direction of the base part to a position farther from the one end in the longitudinal direction of the base part than the measurement-object gas flow cavity, and

the porosity in the posterior region of the inner layer is lower than the porosity in the electrode presence region of the inner layer by 5% by volume or more.

(8) The sensor element according to any one of the above (1) to (7), wherein a porosity of the inner layer is stepwise or continuously decreased in the longitudinal direction of the base part from the one end in the longitudinal direction of the base part.

### Advantageous Effect of the Invention

According to the present invention, it is possible to provide a sensor element that has high water resistance while the adhesion strength between the element body and the inner layer is maintained.

### BRIEF DESCRIPTION OF THE DRAWINGS

FIG. 1 is a perspective view, showing one example of a schematic configuration of a sensor element 101.

FIG. 2 is a vertical sectional schematic view in the longitudinal direction, showing one example of a schematic configuration of a gas sensor 100 including the sensor element 101.

FIG. 2 includes a sectional schematic view of the sensor element 101 along a line II-II in FIG. 1.

FIG. 3 is a schematic sectional view of the same section as shown in FIG. 2, which shows the structure of a porous protective layer 90. In FIG. 3, the components inside an element body 102 are not shown except for a measurement-object gas flow cavity 15, intracavity electrodes and an extracavity electrode.

FIG. 4 is a schematic sectional view of the same section as shown in FIG. 3, which shows the structure of the porous protective layer 90 (an inner layer 91 and an outer layer 92). In FIG. 4, as in the case of FIG. 3, the components inside the element body 102 are not shown except for the measurement-object gas flow cavity 15, the intracavity electrodes and the extracavity electrode.

FIG. 5 is a schematic sectional view of the same section as shown in FIG. 3, which shows the structure of the porous protective layer 90 (the inner layer 91 and the outer layer 92). In FIG. 5, as in the case of FIG. 3, the components inside the element body 102 are not shown except for the measurement-object gas flow cavity 15, the intracavity electrodes and the extracavity electrode.

FIG. 6 is a schematic sectional view of the same section as shown in FIG. 3 to FIG. 5, which shows the structure of a porous protective layer 290 (an inner layer 291 and an outer layer 92) of a sensor element 201 of another example having a porous protective layer with a different structure. In FIG. 6, as in the case of FIG. 3, the components inside the element body 102 are not shown except for the measurement-object gas flow cavity 15, the intracavity electrodes and the extracavity electrode.

FIG. 7 is a flowchart showing an example of a production method of the sensor element.

### MODES FOR CARRYING OUT OF THE INVENTION

A sensor element of the present invention includes:

an element body that includes a base part in an elongated plate shape, including an oxygen-ion-conductive solid electrolyte layer, and a measurement-object gas flow cavity formed on a side of one end in a longitudinal direction of the base part; and

a porous protective layer that is formed from the one end in the longitudinal direction of the base part and covers a surface of a predetermined length in the longitudinal direction of the element body.

The element body includes: an intra-cavity electrode disposed in the measurement-object gas flow cavity; and an extra-cavity electrode that has a predetermined length in the longitudinal direction of the base part, is disposed on one principal surface of two principal surfaces of the element body, and corresponds to the intracavity electrode.

The protective layer includes an inner layer covering the element body and an outer layer positioned outside the inner layer; and has an electrode presence region in which the extracavity electrode exists and a posterior region following to the electrode presence region in the longitudinal direction of the base part; and wherein

a porosity in the posterior region of the inner layer is lower than a porosity in the electrode presence region of the inner layer, and

a porosity of the outer layer is lower than the porosity in the posterior region of the inner layer.

Hereinafter, an example of an embodiment of a gas sensor having the sensor element of the present invention will be described in detail.

### [Schematic Configuration of Gas Sensor]

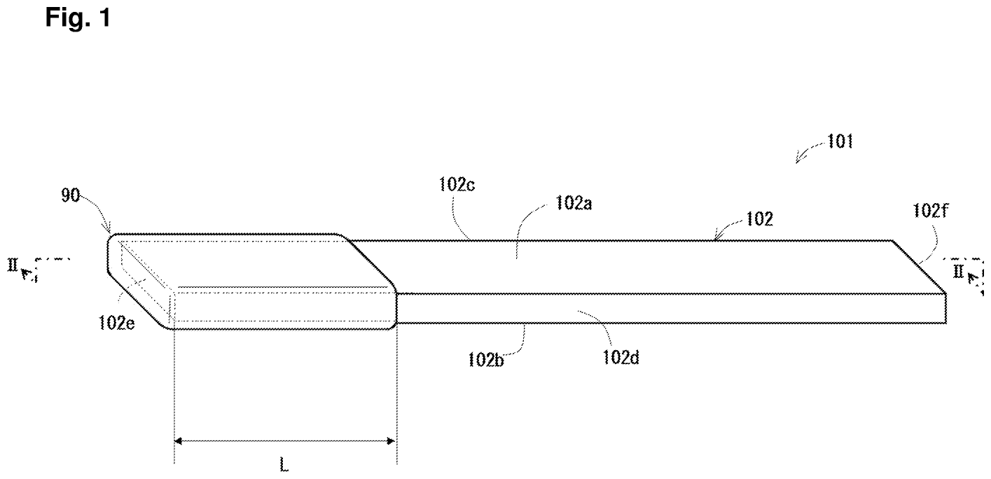

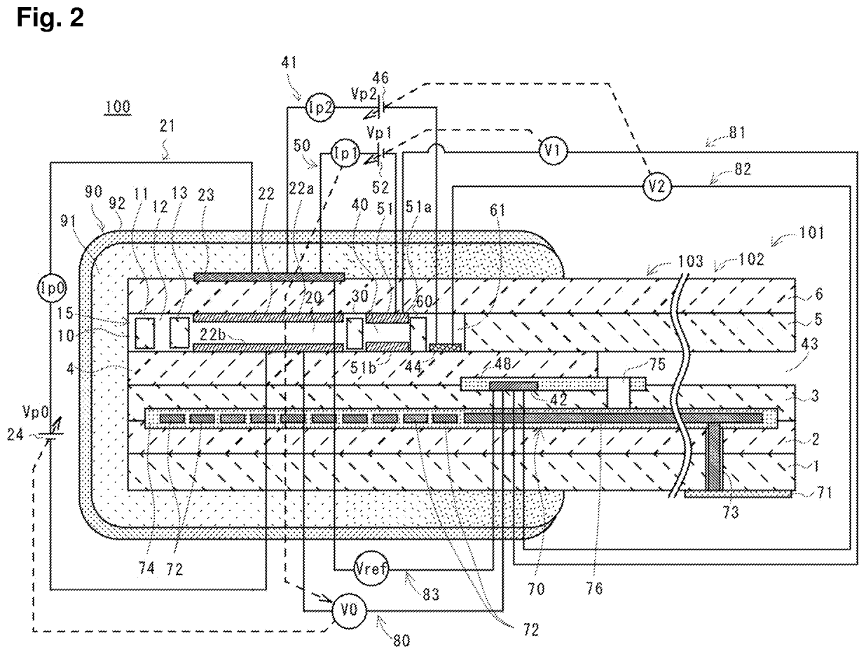

The gas sensor of the present invention will now be described with reference to the drawings. FIG. 1 is a perspective view, showing one example of a schematic configuration of a sensor element 101. FIG. 2 is a vertical sectional schematic view in the longitudinal direction, showing one example of a schematic configuration of the gas sensor 100 including the sensor element 101. In FIG. 2, the sectional schematic view of the sensor element 101 is a sectional schematic view along a line II-II in FIG. 1. Hereinafter, based on FIG. 2, the upper side and the lower side in FIG. 2 are respectively defined as top and bottom, and the left side and the right side in FIG. 2 are respectively defined as a front end side and a rear end side. And, based on FIG. 2, the front side and the back side perpendicular to the paper are respectively defined as a right side and a left side.

In FIG. 2, the gas sensor 100 represents one example of a limiting current type NOx sensor that detects NOx in a measurement-object gas by the sensor element 101, and measures the concentration of NOx.

The sensor element 101 includes a porous protective layer 90 that will be described later in detail. The porous protective layer 90 corresponds to a protective layer of the present invention. A part of the sensor element 101 excluding the porous protective layer 90 is hereinafter referred to as an element body 102. The element body 102 has an elongated plate shape. As shown in FIG. 1, the element body 102 has six surfaces including two principal surfaces (a top surface 102a and a bottom surface 102b), two side surfaces along the longitudinal direction (a left surface 102c and a right surface 102d), and two end surfaces in the longitudinal direction (a front end surface 102e and a rear end surface 102f).

Further, the element body 102 of the sensor element 101 includes an intracavity electrode disposed in a measurement-object gas flow cavity 15 that will be described later; and an extracavity electrode that has a predetermined length in the longitudinal direction of the base part 103, is disposed on one principal surface of the two principal surfaces of the element body 102, and corresponds to the intracavity electrode. The measurement-object gas flow cavity 15 also has a predetermined length in the longitudinal direction of the base part 103. The phrase “corresponds to the intracavity electrode” means that the extracavity electrode is provided to be in contact with the intracavity electrode via the solid electrolyte layer.

In the sensor element 101 of this embodiment, an inner main pump electrode 22, an auxiliary pump electrode 51, and a measurement electrode 44 are provided as intracavity electrodes. As an extracavity electrode, an outer pump electrode 23 is provided on the top surface 102a.

The sensor element 101 is an element in an elongated plate shape, including a base part 103 having such a structure that a plurality of oxygen-ion-conductive solid electrolyte layers are layered. The elongated plate shape also called a long plate shape or a belt shape. The base part 103 has such a structure that six layers, namely, a first substrate layer 1, a second substrate layer 2, a third substrate layer 3, a first solid electrolyte layer 4, a spacer layer 5, and a second solid electrolyte layer 6, are layered in this order from the bottom side, as viewed in the drawing. Each of the six layers is formed of an oxygen-ion-conductive solid electrolyte layer containing, for example, zirconia (ZrO₂). The solid electrolyte forming these six layers is dense and gastight. These six layers all may have the same thickness, or the thickness may vary among the layers. The layers are adhered to each other with an adhesive layer of a solid electrolyte interposed therebetween, and the base part 103 includes the adhesive layer. While a layer configuration composed of the six layers is illustrated in FIG. 2, the layer configuration in the present invention is not limited to this, and any number of layers and any layer configuration are possible.

A gas inlet 10 is formed between the lower surface of the second solid electrolyte layer 6 and the upper surface of the first solid electrolyte layer 4 in one end part in the longitudinal direction (hereinafter, referred to as a front end part) of the sensor element 101. The measurement-object gas flow cavity 15, that is, a measurement-object gas flow part is formed in such a form that a first diffusion-rate limiting part 11, a buffer space 12, a second diffusion-rate limiting part 13, a first internal cavity 20, a third diffusion-rate limiting part 30, a second internal cavity 40, a fourth diffusion-rate limiting part 60, and a third internal cavity 61 communicate in this order in the longitudinal direction from the gas inlet 10.

The gas inlet 10, the buffer space 12, the first internal cavity 20, the second internal cavity 40, and the third internal cavity 61 constitute internal spaces of the sensor element 101. Each of the internal spaces is provided in such a manner that a portion of the spacer layer 5 is hollowed out, and the top of each of the internal spaces is defined by the lower surface of the second solid electrolyte layer 6, the bottom of each of the internal spaces is defined by the upper surface of the first solid electrolyte layer 4, and the lateral surface of each of the internal spaces is defined by the lateral surface of the spacer layer 5.

Each of the first diffusion-rate limiting part 11, the second diffusion-rate limiting part 13, and the third diffusion-rate limiting part 30 is provided as two laterally elongated slits (having the longitudinal direction of the openings in the direction perpendicular to the figure in FIG. 2). Each of the first diffusion-rate limiting part 11, the second diffusion-rate limiting part 13, and the third diffusion-rate limiting part 30 may be in such a form that a desired diffusion resistance is created, but the form is not limited to the slits.

The fourth diffusion-rate limiting part 60 is provided as a single laterally elongated slit (having the longitudinal direction of the opening in the direction perpendicular to the figure in FIG. 2) between the spacer layer 5 and the second solid electrolyte layer 6. The fourth diffusion-rate limiting part 60 may be in such a form that a desired diffusion resistance is created, but the form is not limited to the slit.

Also, at a position farther from the front end than the measurement-object gas flow cavity 15, a reference gas introduction space 43 is disposed between the upper surface of the third substrate layer 3 and the lower surface of the spacer layer 5 at a position where the reference gas introduction space 43 is laterally defined by the lateral surface of the first solid electrolyte layer 4. The reference gas introduction space 43 has an opening in the other end part (hereinafter, referred to as a rear end part) of the sensor element 101. As a reference gas for NOx concentration measurement, for example, air is introduced into the reference gas introduction space 43.

An air introduction layer 48 is a layer formed of porous alumina, and is so configured that a reference gas is introduced into the air introduction layer 48 via the reference gas introduction space 43. The air introduction layer 48 is formed to cover a reference electrode 42.

The reference electrode 42 is an electrode sandwiched between the upper surface of the third substrate layer 3 and the first solid electrolyte layer 4, and as described above, the air introduction layer 48 leading to the reference gas introduction space 43 is disposed around the reference electrode 42. That is, the reference electrode 42 is disposed to be in contact with a reference gas via the air introduction layer 48 which is a porous material, and the reference gas introduction space 43. As will be described later, the reference electrode 42 can be used to measure the oxygen concentration (oxygen partial pressure) in the first internal cavity 20, the second internal cavity 40, and the third internal cavity 61. The reference electrode 42 is formed as a porous cermet electrode (e.g., a cermet electrode of Pt and ZrO₂).

In the measurement-object gas flow cavity 15, the gas inlet 10 is open to the external space, and the measurement-object gas is taken into the sensor element 101 from the external space through the gas inlet 10.

In the present embodiment, the measurement-object gas flow cavity 15 is in such a form that the measurement-object gas is introduced through the gas inlet 10 that is open on the front end surface of the sensor element 101, however, the present invention is not limited to this form. For example, the measurement-object gas flow cavity 15 need not have a recess of the gas inlet 10. In this case, the first diffusion-rate limiting part 11 substantially serves as a gas inlet.

For example, the measurement-object gas flow cavity 15 may have an opening that communicates with the buffer space 12 or a position near the buffer space 12 of the first internal cavity 20, on a lateral surface along the longitudinal direction of the base part 103. In this case, the measurement-object gas is introduced from the lateral surface along the longitudinal direction of the base part 103 through the opening.

Further, for example, the measurement-object gas flow cavity 15 may be so configured that the measurement-object gas is introduced through a porous body.

The first diffusion-rate limiting part 11 creates a predetermined diffusion resistance to the measurement-object gas taken through the gas inlet 10.

The buffer space 12 is provided to guide the measurement-object gas introduced from the first diffusion-rate limiting part 11 to the second diffusion-rate limiting part 13.

The second diffusion-rate limiting part 13 creates a predetermined diffusion resistance to the measurement-object gas introduced into the first internal cavity 20 from the buffer space 12.

It suffices that the amount of the measurement-object gas to be introduced into the first internal cavity 20 finally falls within a predetermined range. That is, it suffices that a predetermined diffusion resistance is created in a whole from the front end part of the sensor element 101 to the second diffusion-rate limiting part 13. For example, the first diffusion-rate limiting part 11 may directly communicate with the first internal cavity 20, or the buffer space 12 and the second diffusion-rate limiting part 13 may be absent.

The buffer space 12 is provided to mitigate the influence of pressure fluctuation on the detected value when the pressure of the measurement-object gas fluctuates.

When the measurement-object gas is introduced from outside the sensor element 101 into the first internal cavity 20, the measurement-object gas, which is rapidly taken through the gas inlet 10 into the sensor element 101 due to pressure fluctuation of the measurement-object gas in the external space (pulsations in exhaust pressure if the measurement-object gas is automotive exhaust gas), is not directly introduced into the first internal cavity 20. Rather, the measurement-object gas is introduced into the first internal cavity 20 after the pressure fluctuation of the measurement-object gas is eliminated through the first diffusion-rate limiting part 11, the buffer space 12, and the second diffusion-rate limiting part 13. Thus, the pressure fluctuation of the measurement-object gas introduced into the first internal cavity 20 becomes almost negligible.

The first internal cavity 20 is provided as a space for adjusting the oxygen partial pressure in the measurement-object gas introduced through the second diffusion-rate limiting part 13. The oxygen partial pressure is adjusted by operation of a main pump cell 21.

The main pump cell 21 is an electrochemical pump cell including the inner main pump electrode 22 as an intracavity electrode disposed in the measurement-object gas flow cavity 15, and the outer pump electrode 23 as an extracavity electrode disposed to be in contact with the inner main pump electrode 22 via a solid electrolyte (in FIG. 2, via the second solid electrolyte layer 6). The outer pump electrode 23 is disposed on the top surface 102a of the two principal surfaces of the element body 102.

That is, the main pump cell 21 is an electrochemical pump cell composed of the inner main pump electrode 22 having a ceiling electrode portion 22a disposed over substantially the entire surface of the lower surface of the second solid electrolyte layer 6 that faces the first internal cavity 20, the outer pump electrode 23 disposed on a region of the upper surface of the second solid electrolyte layer 6 that corresponds to the ceiling electrode portion 22a so as to be exposed to the external space, and the second solid electrolyte layer 6 sandwiched between the inner main pump electrode 22 and the outer pump electrode 23.

The inner main pump electrode 22 is disposed facing the first internal cavity 20. That is, the inner main pump electrode 22 is formed to span the upper and lower solid electrolyte layers (the second solid electrolyte layer 6 and the first solid electrolyte layer 4) that define the first internal cavity 20 and the spacer layer 5 that defines the lateral wall. Specifically, the ceiling electrode portion 22a is formed on the lower surface of the second solid electrolyte layer 6 that defines the ceiling surface of the first internal cavity 20, and a bottom electrode portion 22b is formed on the upper surface of the first solid electrolyte layer 4 that defines the bottom surface of the first internal cavity 20. Also, lateral electrode portions (not shown) are formed on the lateral wall surfaces (inner surface) of the spacer layer 5 that form both lateral wall parts of the first internal cavity 20 so as to connect the ceiling electrode portion 22a and the bottom electrode portion 22b. Thus, the inner main pump electrode 22 is provided as a tunnel-like structure in the area where the lateral electrode portions are disposed.

The inner main pump electrode 22 and the outer pump electrode 23 are each formed as a porous cermet electrode (e.g., a cermet electrode of Pt containing 1% Au and ZrO₂). It is to be noted that the inner main pump electrode 22 to be in contact with the measurement-object gas is formed using a material having a weakened ability to reduce a NOx component in the measurement-object gas.

In the main pump cell 21, a desired pump voltage Vp0 is applied between the inner main pump electrode 22 and the outer pump electrode 23 by a variable power supply 24 to flow a pump current Ip0 between the inner main pump electrode 22 and the outer pump electrode 23 in either a positive or negative direction, and thus it is possible to pump out oxygen in the first internal cavity 20 to the external space or pump oxygen into the first internal cavity 20 from the external space.

To detect the oxygen concentration (oxygen partial pressure) in the atmosphere in the first internal cavity 20, the inner main pump electrode 22, the second solid electrolyte layer 6, the spacer layer 5, the first solid electrolyte layer 4, the third substrate layer 3, and the reference electrode 42 form an electrochemical sensor cell, namely, an oxygen-partial-pressure detection sensor cell 80 for main pump control.

The oxygen concentration (oxygen partial pressure) in the first internal cavity 20 can be detected from an electromotive force V0 measured in the oxygen-partial-pressure detection sensor cell 80 for main pump control. In addition, the pump current Ip0 is controlled by performing feedback control of the pump voltage Vp0 in the variable power supply 24 so that the electromotive force V0 is constant. Thus, the oxygen concentration in the first internal cavity 20 can be maintained at a predetermined constant value.

The third diffusion-rate limiting part 30 creates a predetermined diffusion resistance to the measurement-object gas whose oxygen concentration (oxygen partial pressure) has been controlled in the first internal cavity 20 by the operation of the main pump cell 21, and guides the measurement-object gas into the second internal cavity 40.

The second internal cavity 40 is provided as a space for adjusting the oxygen partial pressure in the measurement-object gas introduced through the third diffusion-rate limiting part 30 more accurately. The oxygen partial pressure is adjusted by operation of an auxiliary pump cell 50. The sensor element 101 may be configured without the second internal cavity 40 and the auxiliary pump cell 50. From the viewpoint of adjusting accuracy of oxygen partial pressure, it is more preferred that the second internal cavity 40 and the auxiliary pump cell 50 be provided.

After the oxygen concentration (oxygen partial pressure) in the measurement-object gas is adjusted in advance in the first internal cavity 20, the measurement-object gas is introduced through the third diffusion-rate limiting part 30, and is further subjected to adjustment of the oxygen partial pressure by the auxiliary pump cell 50 in the second internal cavity 40. Thus, the oxygen concentration in the second internal cavity 40 can be kept constant with high accuracy, and the NOx concentration can be measured with high accuracy in the gas sensor 100.

The auxiliary pump cell 50 is an electrochemical pump cell including the auxiliary pump electrode 51 as an intracavity electrode disposed at a position farther from the front end portion of the base part 103 than the inner main pump electrode 22 in the measurement-object gas flow cavity 15, and the outer pump electrode 23 as an extracavity electrode disposed to be in contact with the auxiliary pump electrode 51 via a solid electrolyte (in FIG. 2, via the second solid electrolyte layer 6).

That is, the auxiliary pump cell 50 is an auxiliary electrochemical pump cell composed of the auxiliary pump electrode 51 having a ceiling electrode portion 51a disposed on substantially the entire surface of the lower surface of the second solid electrolyte layer 6 facing with the second internal cavity 40, the outer pump electrode 23 (the outer electrode is not limited to the outer pump electrode 23, but may be any suitable electrode at a position different from the measurement-object gas flow cavity 15, for example, outside the sensor element 101), and the second solid electrolyte layer 6.

The auxiliary pump electrode 51 is disposed in the second internal cavity 40 in a tunnel-like structure similar to the inner main pump electrode 22 disposed in the first internal cavity 20. Specifically, in the tunnel-like structure, the ceiling electrode portion 51a is formed on the second solid electrolyte layer 6 that defines the ceiling surface of the second internal cavity 40, a bottom electrode portion 51b is formed on the first solid electrolyte layer 4 that defines the bottom surface of the second internal cavity 40, and lateral electrode portions (not shown) connecting the ceiling electrode portion 51a and the bottom electrode portion 51b are formed on the wall surfaces of the spacer layer 5 that define the lateral walls of the second internal cavity 40.

It is to be noted that the auxiliary pump electrode 51 is formed using a material having a weakened ability to reduce a NOx component in the measurement-object gas, as with the case of the inner main pump electrode 22.

In the auxiliary pump cell 50, by applying a desired voltage Vp1 between the auxiliary pump electrode 51 and the outer pump electrode 23 by a valuable power supply 52, it is possible to pump out oxygen in the atmosphere in the second internal cavity 40 to the external space, or pump the oxygen into the second internal cavity 40 from the external space.

To control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electrochemical sensor cell, namely, an oxygen-partial-pressure detection sensor cell 81 for auxiliary pump control.

The auxiliary pump cell 50 performs pumping with the variable power supply 52 whose voltage is controlled on the basis of an electromotive force V1 detected by the oxygen-partial-pressure detection sensor cell 81 for auxiliary pump control. Thus, the oxygen partial pressure in the atmosphere in the second internal cavity 40 is controlled to such a low partial pressure that does not substantially affect measurement of NOx.

In addition, a pump current Ip1 is used for control of the electromotive force of the oxygen-partial-pressure detection sensor cell 80 for main pump control. Specifically, the pump current Ip1 is input to the oxygen-partial-pressure detection sensor cell 80 for main pump control as a control signal to control the electromotive force V0, and thus the gradient of the oxygen partial pressure in the measurement-object gas introduced into the second internal cavity 40 from the third diffusion-rate limiting part 30 is controlled to remain constant. In using as a NOx sensor, the oxygen concentration in the second internal cavity 40 is kept at a constant value of about 0.001 ppm by the actions of the main pump cell 21 and the auxiliary pump cell 50.

The fourth diffusion-rate limiting part 60 creates a predetermined diffusion resistance to the measurement-object gas whose oxygen concentration (oxygen partial pressure) has been controlled to further low in the second internal cavity 40 by the operation of the auxiliary pump cell 50, and guides the measurement-object gas into the third internal cavity 61.

The third internal cavity 61 is provided as a space for measuring nitrogen oxide (NOx) concentration in the measurement-object gas introduced through the fourth diffusion-rate limiting part 60. By the operation of a measurement pump cell 41, NOx concentration is measured.

The measurement pump cell 41 measures NOx concentration in the measurement-object gas in the third internal cavity 61. The measurement pump cell 41 is an electrochemical pump cell including the measurement electrode 44 as an intracavity electrode disposed at a position farther from the front end portion of the base part 103 than the auxiliary pump electrode 51 in the measurement-object gas flow cavity 15, and the outer pump electrode 23 as an extracavity electrode disposed to be in contact with the measurement electrode 44 via a solid electrolyte (in FIG. 2, via the second solid electrolyte layer 6, the spacer layer 5, and the first solid electrolyte layer 4).

That is, the measurement pump cell 41 is an electrochemical pump cell composed of the measurement electrode 44 disposed on the upper surface of the first solid electrolyte layer 4 facing with the third internal cavity 61, the outer pump electrode 23 (the outer electrode is not limited to the outer pump electrode 23, but may be any suitable electrode at a position different from the measurement-object gas flow cavity 15, for example, outside the sensor element 101), the second solid electrolyte layer 6, the spacer layer 5, and the first solid electrolyte layer 4.

The measurement electrode 44 is a porous cermet electrode. The measurement electrode 44 functions also as a NOx reduction catalyst that reduces NOx present in the atmosphere in the third internal cavity 61. The measurement electrode 44 contains a noble metal having catalytic activity (e.g., at least one of Pt, Rh, Ir, Ru, and Pd) as a metal component.

In the measurement pump cell 41, oxygen generated by decomposition of nitrogen oxide in the atmosphere around the measurement electrode 44 is pumped out, and the amount of generated oxygen can be detected as a pump current Ip2.

To detect the oxygen partial pressure around the measurement electrode 44, the first solid electrolyte layer 4, the third substrate layer 3, the measurement electrode 44, and the reference electrode 42 constitute an electrochemical sensor cell, namely an oxygen-partial-pressure detection sensor cell 82 for measurement pump control. A variable power supply 46 is controlled on the basis of an electromotive force V2 detected by the oxygen-partial-pressure detection sensor cell 82 for measurement pump control.

The measurement-object gas introduced into the second internal cavity 40 reaches the measurement electrode 44 through the fourth diffusion-rate limiting part 60 under the condition that the oxygen partial pressure is controlled. Nitrogen oxide in the measurement-object gas around the measurement electrode 44 is reduced (2NO→N₂+O₂) to generate oxygen. The generated oxygen is to be pumped by the measurement pump cell 41, and at this time, a voltage Vp2 of the variable power supply 46 is controlled so that the electromotive force V2 detected by the oxygen-partial-pressure detection sensor cell 82 for measurement pump control is constant. Since the amount of oxygen generated around the measurement electrode 44 is proportional to the concentration of nitrogen oxide in the measurement-object gas, nitrogen oxide concentration in the measurement-object gas is calculated by using the pump current Ip2 in the measurement pump cell 41.

By configuring oxygen partial pressure detecting means by an electrochemical sensor cell composed of a combination of the measurement electrode 44, the first solid electrolyte layer 4, the third substrate layer 3 and the reference electrode 42, it is possible to detect an electromotive force in accordance with a difference between the amount of oxygen generated by reduction of NOx components in the atmosphere around the measurement electrode 44 and the amount of oxygen contained in the reference air, and hence it is possible to determine the concentration of NOx components in the measurement-object gas.

Also, the second solid electrolyte layer 6, the spacer layer 5, the first solid electrolyte layer 4, the third substrate layer 3, the outer pump electrode 23, and the reference electrode 42 constitute an electrochemical sensor cell 83, and it is possible to detect the oxygen partial pressure in the measurement-object gas outside the sensor by an electromotive force Vref obtained by the sensor cell 83.

In the gas sensor 100 having such a configuration, the main pump cell 21 and the auxiliary pump cell 50 are operated to supply a measurement-object gas whose oxygen partial pressure is usually kept at a low constant value (the value that does not substantially affect measurement of NOx) to the measurement pump cell 41. Therefore, NOx concentration in the measurement-object gas can be detected on the basis of the pump current Ip2 that flows as a result of pumping out of the oxygen generated by reduction of NOx by the measurement pump cell 41 and is almost in proportion to the concentration of NOx in the measurement-object gas.

The sensor element 101 further includes a heater part 70 that functions as a temperature regulator of heating and maintaining the temperature of the sensor element 101 so as to enhance the oxygen ion conductivity of the solid electrolyte. The heater part 70 includes a heater electrode 71, a heater 72, a heater lead 76, a through hole 73, a heater insulating layer 74, and a pressure relief vent 75.

The heater electrode 71 is an electrode formed in contact with the lower surface of the first substrate layer 1. The power can be supplied to the heater part 70 from the outside by connecting the heater electrode 71 with a heater power supply that is an external power supply.

The heater 72 is an electrical resistor sandwiched by the second substrate layer 2 and the third substrate layer 3 from top and bottom. The heater 72 is connected with the heater electrode 71 via the heater lead 76 that connects with the heater 72 and extends in the rear end side in the longitudinal direction of the sensor element 101, and the through hole 73. The heater 72 is externally powered through the heater electrode 71 to generate heat, and heats and maintains the temperature of the solid electrolyte forming the sensor element 101.

The heater 72 is embedded over the whole area from the first internal cavity 20 to the third internal cavity 61 so that the temperature of the entire sensor element 101 can be adjusted to such a temperature that activates the solid electrolyte. The temperature may be adjusted so that the main pump cell 21, the auxiliary pump cell 50, and the measurement pump cell 41 are operable. It is not necessary that the whole area is adjusted to the same temperature, but the sensor element 101 may have temperature distribution.

In the sensor element 101 of the present embodiment, the heater 72 is embedded in the base part 103, but this form is not limitative. The heater 72 may be disposed to heat the base part 103. That is, the heater 72 may heat the sensor element 101 to develop oxygen ion conductivity with which the main pump cell 21, the auxiliary pump cell 50, and the measurement pump cell 41 are operable. For example, the heater 72 may be embedded in the base part 103 as in the present embodiment. Alternatively, for example, the heater part 70 may be formed as a heater substrate that is separate from the base part 103, and may be disposed at a position adjacent to the base part 103.

The heater insulating layer 74 is formed of an insulator such as alumina on the upper and lower surfaces of the heater 72 and the heater lead 76. The heater insulating layer 74 is formed to ensure electrical insulation between the second substrate layer 2, and the heater 72 and the heater lead 76, and electrical insulation between the third substrate layer 3, and the heater 72 and the heater lead 76.

The pressure relief vent 75 extends through the third substrate layer 3 so that the heater insulating layer 74 and the reference gas introduction space 43 communicate with each other. The pressure relief vent 75 can mitigate an increase in internal pressure due to temperature rise in the heater insulating layer 74. The pressure relief vent 75 may be absent.

### (Protective Layer)

The sensor element 101 includes the element body 102 and the porous protective layer 90 that is formed from the one end in the longitudinal direction of the element body 102 (the base part 103) and covers a surface of a predetermined length L in the longitudinal direction of the element body 102. Here, the one end in the longitudinal direction of the element body 102 is the one end on a side of which the measurement-object gas flow cavity 15 is formed, namely, the front end of the element body 102. The element body 102 is in an elongated plate shape, and the top surface 102a and the bottom surface 102b of the element body 102 are principal surfaces. The left surface 102c and the right surface 102d are also referred to as the side surfaces, and the front end surface 102e and the rear end surface 102f are also referred to as the end surfaces.

The porous protective layer 90 includes an inner layer 91 covering the element body 102 and an outer layer 92 positioned outside the inner layer 91, and has an electrode presence region in which the extracavity electrode (in this embodiment, the outer pump electrode 23) exists and a posterior region following to the electrode presence region in the longitudinal direction of the element body 102 (the base part 103).

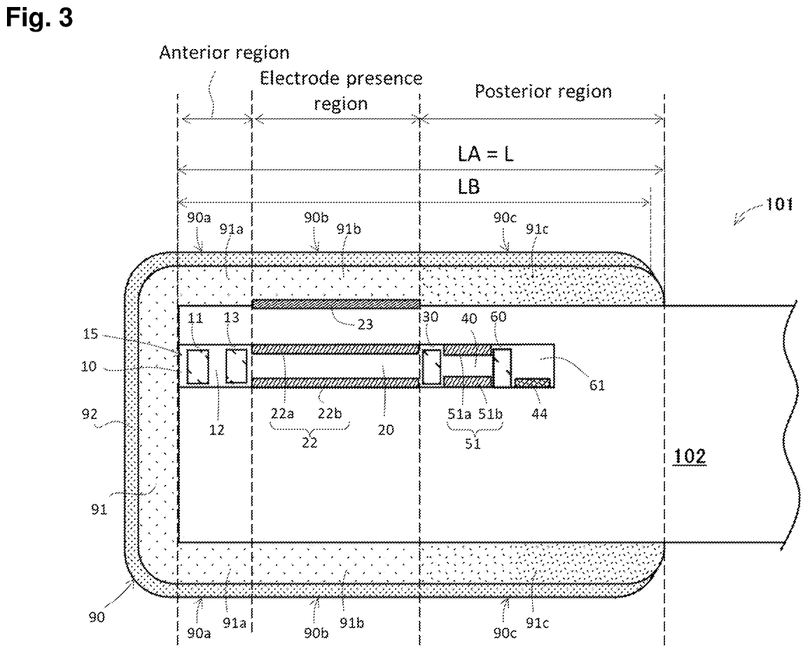

FIG. 3 is a schematic sectional view of the same section as shown in FIG. 2, which shows the structure of the porous protective layer 90. In FIG. 3, the components inside the element body 102 are not shown except for the measurement-object gas flow cavity 15, the intracavity electrodes and the extracavity electrode. As shown in FIG. 3, in the longitudinal direction of the element body 102 (the base part 103), a region in which the outer pump electrode 23 exists in the porous protective layer 90 is referred to as an electrode presence region 90b. A region from the front end of the element body 102 (the base part 103) to the front end of the electrode presence region 90b in the porous protective layer 90 is referred to as an anterior region 90a. A region following to the electrode presence region 90b, that is, a region from a rear end of the electrode presence region 90b to a rear end of the porous protective layer 90 in the porous protective layer 90 on the pump surface 102a of the element body 102 is referred to as a posterior region 90c. The rear end of the anterior region 90a is in contact with the front end of the electrode presence region 90b, and the rear end of the electrode presence region 90b is in contact with the front end of the posterior region 90c. In the porous protective layer 90, a porosity in a posterior region 91c of the inner layer 91 is lower than a porosity in an electrode presence region 91b of the inner layer 91. The porosity of the outer layer 92 is usually lower than a porosity at any position in the inner layer 91. The porosity will be described later in detail.

In this embodiment, the porous protective layer 90 covers a predetermined area (an area indicated by a broken line in FIG. 1) of the element body 102 in the longitudinal direction from the front end of the element body 102. In more detail, the porous protective layer 90 entirely covers a part of the top surface 102a of the element body 102 which extends for a predetermined length L in the longitudinal direction from the front end of the element body 102. The porous protective layer 90 entirely covers a part of the bottom surface 102b of the element body 102 which extends for a length L in the longitudinal direction from the front end of the element body 102. The porous protective layer 90 entirely covers a part of the left surface 102c of the element body 102 which extends for a length L in the longitudinal direction from the front end of the element body 102. The porous protective layer 90 entirely covers a part of the right surface 102d of the element body 102 which extends for a length L in the longitudinal direction from the front end of the element body 102. The porous protective layer 90 entirely covers the front end surface 102e of the element body 102.

As shown in FIG. 2, the porous protective layer 90 also covers the gas inlet 10. However, a measurement-object gas can reach the gas inlet 10 through the inside of the porous protective layer 90 because the porous protective layer 90 is a porous material. Therefore, a target gas to be measured can be detected and measured without problem.

The porous protective layer 90 plays a role of suppressing the occurrence of cracking in the internal structure of the element body 102 when, for example, water is splashed on the sensor element 101 having a high temperature during operation of the gas sensor. Water that has reached the sensor element 101 is not directly attached to the surface of the element body 102 but is attached to the porous protective layer 90. The surface of the porous protective layer 90 is rapidly cooled by the attached water, but thermal shock applied to the element body 102 is reduced by the heat insulating effect of the porous protective layer 90. This, as a result, makes it possible to suppress the occurrence of cracking in the internal structure of the element body 102. That is, the water resistance of the sensor element 101 improves.

The porous protective layer 90 may cover the outer pump electrode 23. The porous protective layer 90 also plays a role of suppressing the attachment of an oil component or the like contained in a measurement-object gas to the outer pump electrode 23 to prevent degradation of the outer pump electrode 23.

The porous protective layer 90 comprises a porous material. Examples of a constituent material of the porous protective layer 90 include alumina, zirconia, spinel, cordierite, mullite, titania, and magnesia. Any one or two or more of them may be used. A constituent material of the inner layer 91 and a constituent material of the outer layer 92 may be the same, or may be different from each other. In this embodiment, the porous protective layer 90 (the inner layer 91 and the outer layer 92) comprises an alumina porous material.

The inner layer 91 is formed so as to cover a predetermined area of the element body 102 in the longitudinal direction from the front end of the element body 102. In more detail, the inner layer 91 entirely covers a part of the top surface 102a of the element body 102 which extends for a predetermined length LA in the longitudinal direction from the front end of the element body 102. The inner layer 91 entirely covers a part of the bottom surface 102b of the element body 102 which extends for a length LA in the longitudinal direction from the front end of the element body 102. The inner layer 91 entirely covers a part of the left surface 102c of the element body 102 which extends for a length LA in the longitudinal direction from the front end of the element body 102. The inner layer 91 entirely covers a part of the right surface 102d of the element body 102 which extends for a length LA in the longitudinal direction from the front end of the element body 102. The inner layer 91 entirely covers the front end surface 102e of the element body 102. In this embodiment, the length LA in the longitudinal direction of the inner layer 91 is the same as the length L in the longitudinal direction of the porous protective layer 90 (LA=L). Hereinafter, the top surface 102a is also referred to as a pump surface 102a. One principal surface (the bottom surface 102b) of the two principal surfaces of the element body 102 opposite to the pump surface 102a is also referred to as a heater surface 102b.

The outer layer 92 is positioned outside the inner layer 91. In this embodiment, the outer layer 92 is formed so as to almost entirely cover a surface of the inner layer 91. That is, the outer layer 92 is formed so as to cover a predetermined area of the element body 102 in the longitudinal direction from the front end of the inner layer 91. In this embodiment, the outer layer 92 entirely covers a part of the inner layer 91 which extends to a position of a predetermined length LB in the longitudinal direction from the front end of the element body 102. In this embodiment, the length LB in the longitudinal direction of the outer layer 92 is shorter than the length LA in the longitudinal direction of the inner layer 91 (LB<LA). That is, a rear end part of the inner layer 91 is not covered with the outer layer 92 and is exposed. However, the length LB in the longitudinal direction of the outer layer 92 is not limited thereto. The length LB in the longitudinal direction of the outer layer 92 may be the same as the length LA in the longitudinal direction of the inner layer 91 (LB=LA). Further, the length LB in the longitudinal direction of the outer layer 92 may be longer than the length LA in the longitudinal direction of the inner layer 91 (LB>LA). That is, the inner layer 91 may completely by covered with the outer layer 92 (in this case, LA<LB=L). In this embodiment, on all the surfaces of the two principal surfaces (the pump surface 102a and the heater surface 102b) and two side surfaces (the left surface 102c and the right surface 102d), the respective lengths LB in the longitudinal direction of the outer layer 92 are the same. However, the lengths LB in the longitudinal direction of the outer layer 92 on the two principal surfaces and two side surfaces may be different from each other.

As such, the porous protective layer 90 includes an inner layer 91 covering the element body 102 and an outer layer 92 positioned outside the inner layer 91. A porosity of the outer layer 92 is lower than a porosity at any position in the inner layer 91. In the porous protective layer 90, the inner layer 91 mainly plays a role of suppressing thermal conduction from the surface of the sensor element 101 (the surface of the porous protective layer 90) to the element body 102. In other words, the inner layer 91 has a function of reducing thermal shock applied to the element body 102 by the heat insulating effect of the inner layer 91. Further, the outer layer 92 having a lower porosity than the inner layer 91 mainly has a function of maintaining structural strength of the porous protective layer 90 as a whole. The outer layer 92 also has a function of preventing water droplets from penetrating into the inside of the porous protective layer 90 (the inside of the inner layer 91). This prevents evaporation of water inside the inner layer 91 and reduces thermal shock applied to the element body 102.

As described above, the porous protective layer 90 has a predetermined length L in the longitudinal direction of the element body 102 (the base part 103), and includes the electrode presence region 90b in which the outer pump electrode 23 exists, and the posterior region 90c following to the rear of the electrode presence region 90b. The inner layer 91 of the porous protective layer 90 has a predetermined length LA in the longitudinal direction of the element body 102 (the base part 103), and extend to the electrode presence region 91b in which the outer pump electrode 23 exists, and the posterior region 91c following to the rear of the electrode presence region 91b. In this embodiment, L=LA.

The porous protective layer 90 (especially, the inner layer 91) may cover a portion having a high temperature during the driving of the gas sensor in the element body 102. The length L in the longitudinal direction of the porous protective layer 90 and the length LA in the longitudinal direction of the inner layer 91 may be appropriately determined to fall within a range longer than a length in the longitudinal direction from the front end surface of the element body 102 to a rear end of the electrode presence region 90b, 91b (a rear end-side electrode end of the outer pump electrode 23) and equal to or shorter than a whole length of the element body 102 in the longitudinal direction, on the basis of the area of the element body 102 to be exposed to a measurement-object gas in the gas sensor 100, the position of the outer pump electrode 23, the position of the measurement-object gas flow cavity 15, temperature distribution of the element body 102, or the like.

The inner layer 91 covers a part from the front end of the element body 102 to an area rear of the electrode presence region 91b in which the outer pump electrode 23 exists in the element body 102. Preferably, the inner layer 91 may cover at least a part from the front end of the element body 102 to a position at a rear end of the measurement-object gas flow cavity 15. That is, the posterior region 91c of the inner layer 91 (the posterior region 90c of the porous protective layer 90) may extend in the longitudinal direction of the base part 103 to a position farther from the one end (the front end) in the longitudinal direction of the base part 103 than the measurement-object gas flow cavity 15. The position where the measurement-object gas flow cavity 15 exists is usually at such a high temperature that oxygen ion conductivity of the solid electrolyte is developed during the driving of the gas sensor. By covering such a range with the inner layer 91, it is possible to effectively reduce thermal shock applied to a portion with high temperature in the element body 102.

For example, the inner layer 91 may almost entirely cover a portion exposed to the measurement-object gas in the element body 102. For example, the inner layer 91 may be formed to cover almost the entirety from the front end of the element body 102 to a position in the longitudinal direction in which the reference electrode 42 is formed. Alternatively, for example, the inner layer 91 may be formed to cover almost the entirety from the front end of the element body 102 to a position of a front end-side side surface of the reference gas introduction space 43 in the longitudinal direction. Alternatively, the inner layer 91 may cover almost from the front end of the element body 102 to a position farther from the position of the front end-side side surface of the reference gas introduction space 43 in the longitudinal direction. In this embodiment, on all the surfaces of the two principal surfaces (the pump surface 102a and the heater surface 102b) and two side surfaces (the left surface 102c and the right surface 102d), the respective lengths LA in the longitudinal direction of the inner layer 91 are the same. However, the lengths LA in the longitudinal direction of the inner layer 91 on the two principal surfaces and two side surfaces may be different from each other.

The length LA of the inner layer 91 in the longitudinal direction from the front end of the element body 102 may vary depending on the structure of the element body 102, and may be, for example, 7 mm or more, 9 mm or more, or 10 mm or more. The length LA may be, for example, 17 mm or less, or 14 mm or less.

The outer layer 92 covers the surface of the inner layer 91 covering the front end surface 102e of the element body 102, and covers a part of the inner layer 91 which extends for a predetermined length LB in the longitudinal direction from the front end of the element body 102. The outer layer 92 may cover the inner layer 91 so as to maintain structural strength of the porous protective layer 90 as a whole. The outer layer 92 may completely cover the inner layer 91 (LB>LA), and a part including the rear end in the longitudinal direction of the inner layer 91 may be exposed (LB<LA) as shown in FIG. 3. The lengths may be LB=LA. In this embodiment, on all the surfaces of the two principal surfaces (the pump surface 102a and the heater surface 102b) and two side surfaces (the left surface 102c and the right surface 102d), the respective lengths LB in the longitudinal direction of the outer layer 92 are the same. However, the lengths LB in the longitudinal direction of the outer layer 92 on the two principal surfaces and two side surfaces may be different from each other. Further, magnitude relations (LB>LA, LB=LA, or LB<LA) between the length LB in the longitudinal direction the outer layer 92 and the length LA in the longitudinal direction of the inner layer 91 on the two principal surfaces and two side surfaces may be different from each other.

The length LB of the outer layer 92 in the longitudinal direction from the front end of the element body 102 may vary depending on the structure of the element body 102, and may be, for example, 7 mm or more, 9 mm or more, or 10 mm or more. The length LB may be, for example, 17 mm or less, or 14 mm or less. Preferably, the length LB of the outer layer 92 in the longitudinal direction from the front end of the element body 102 may not be too shorter than the length LA of the inner layer 91 in the longitudinal direction from the front end of the element body 102. When the length LB is within such a range, it is considered to be possible to maintain the higher structural strength of the porous protective layer 90 as a whole. For example, the length LB in the longitudinal direction of the outer layer 92 may be 80% or more, 85% or more, 90% more, or the like relative to the length LA in the longitudinal direction of the inner layer 91.

The length L of the entire porous protective layer 90 in the longitudinal direction from the front end of the element body 102 may vary depending on the structure of the element body 102, and may be, for example, 7 mm or more, 9 mm or more, or 10 mm or more. The length L may be, for example, 17 mm or less, or 14 mm or less. In this embodiment, on all the surfaces of the two principal surfaces (the pump surface 102a and the heater surface 102b) and two side surfaces (the left surface 102c and the right surface 102d), the respective lengths L in the longitudinal direction of the porous protective layer 90 are the same. However, the lengths L in the longitudinal direction of the porous protective layer 90 on the two principal surfaces and two side surfaces may be different from each other.

A thickness of the inner layer 91 may be, for example, 200 μm or more and 800 μm or less. In this embodiment, the inner layers 91 of the porous protective layers 90 on respective surfaces of the element body 102 all have the same thickness. However, the inner layers 91 on the respective surfaces may be different from each other in thickness. A thickness of the outer layer 92 may be 100 μm or more and 400 μm or less. In this embodiment, the outer layers 92 of the porous protective layers 90 on respective surfaces of the element body 102 all have the same thickness. However, the outer layers 92 on the respective surfaces may be different from each other in thickness.

The thickness is determined in the following manner using an image (SEM image) obtained by observation with a scanning electron microscope (SEM). In an area where the element body 102 is present (for example, a position around center in the width direction of the sensor element 101), the sensor element 101 is cut in the longitudinal direction of the sensor element 101. The cut surface is embedded in a resin and polished to prepare an observation sample. The magnification of the SEM is set to 80 times, and the surface to be observed of the observation sample is imaged to obtain an SEM image of section of the porous protective layer 90. A direction perpendicular to the surface of the element body 102 is defined as a thickness direction, a distance between the surface of the outer layer 92 (the surface of the porous protective layer 90) and the interface with the inner layer 91 is determined, and the distance is defined as the thickness of the outer layer 92. A distance between the surface of the inner layer 91 and the interface with the element body 102 is determined, and the distance is defined as the thickness of the inner layer 91. Further, a distance between the surface of the outer layer 92 (the surface of the porous protective layer 90) and the interface with the element body 102 is determined, and the distance is defined as the thickness of the porous protective layer 90. The thickness of the porous protective layer 90 may also be obtained by calculating a sum of the determined thickness of the outer layer 92 and the determined thickness of the inner layer 91.

As shown in FIG. 3, normally, near the rear end in the longitudinal direction of the porous protective layer 90, the thickness of the inner layer 91 is gradually reduced toward the rear end. Corners of the front end in the longitudinal direction of the porous protective layer 90 are usually rounded. The determination of the thickness described above is carried out in a region having a uniform thickness (in a region other than the front end portion and the rear end portion) of the porous protective layer 90.

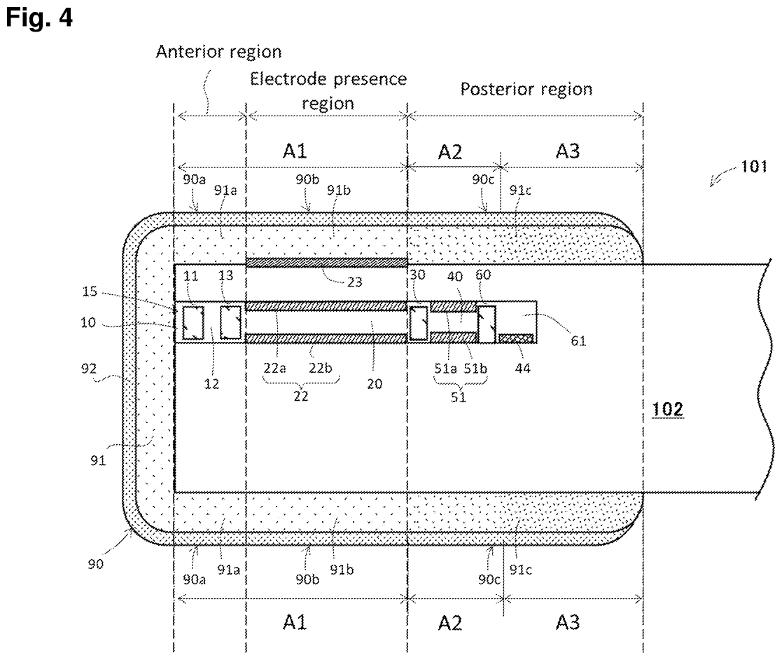

Next, a porosity in the inner layer 91 of the porous protective layer 90 will be described. FIG. 4 is a schematic sectional view of the same section as shown in FIG. 3, which shows the structure of the porous protective layer 90 (the inner layer 91 and the outer layer 92). In FIG. 4, as in the case of FIG. 3, the components inside the element body 102 are not shown except for the measurement-object gas flow cavity 15, the intracavity electrodes and the extracavity electrode.

As described above, the inner layer 91 has a function of reducing thermal shock applied to the element body 102 by the heat insulating effect of the inner layer 91. The higher the porosity of the inner layer 91, the lower the thermal conductivity of the inner layer 91, and thus the heat insulating effect is improved. However, it is concerned that the higher the porosity of the inner layer 91, the more the adhesion strength between the element body 102 and the inner layer 91 decreases. The present inventors have intensively studied and found that, in the inner layer 91, by making a porosity in the posterior region 91c of the inner layer 91 lower than a porosity in the electrode presence region 91b of the inner layer 91, the heat insulating effect can be improved while the adhesion strength between the element body 102 and the inner layer 91 is maintained. That is, by making a porosity in the posterior region 91c of the inner layer 91 decrease, the adhesion strength between the element body 102 and the inner layer 91 can be improved. In the posterior region 91c of the inner layer 91, by adhering the element body 102 and the inner layer 91 with sufficient strength, high adhesion strength can be maintained in the inner layer 91 as a whole. In the electrode presence region 91b of the inner layer 91, high heat insulating effect can be obtained due to the high porosity.

As described above, in the inner layer 91, the porosity in the posterior region 91c of the inner layer 91 is lower than the porosity in the electrode presence region 91b of the inner layer 91. In other words, the inner layer 91 has different porosity in the longitudinal direction of the element body 102 (the base part 103). As shown in FIG. 4, this embodiment shows an example in which the porosity decreases stepwise in an area A1, an area A2, and an area A3 in this order from the front end of the element body 102 (the base part 103) rearward in the longitudinal direction. The area A1 is in an anterior region 91a and the electrode presence region 91b, and the area A2 and the area A3 are in the posterior region 91c. At any position in the longitudinal direction in the posterior region 91c of the inner layer 91, the porosity in the posterior region 91c is lower than the porosity in the electrode presence region 91b.

Preferably, in the longitudinal direction of the base part 103, a porosity in a region farther from the one end (the front end) in the longitudinal direction of the base part 103 than the measurement-object gas flow cavity 15 in the posterior region 91c of the inner layer 91 is lower than the porosity in the electrode presence region 91b of the inner layer 91.

A porosity in the posterior region 91c of the inner layer 91 may be, for example, 30% by volume or more and 50% by volume or less. When the porosity in the posterior region 91c is within such a range, it is possible to maintain high structural strength of the inner layer 91. Here, the porosity in the posterior region 91c may be an average porosity in the posterior region 91c. Alternatively, a porosity at a predetermined position (for example, a center position) in the longitudinal direction of the posterior region 91c may be used as a porosity in the posterior region 91c. The porosity in the posterior region 91c of the inner layer 91 may be, for example, 30% by volume or more and 45% by volume or less, or, 30% by volume or more and 40% by volume or less.

When the porosity decreases stepwise in the area A2 and the area A3 in this order in the posterior region 91c as this embodiment, a porosity in the area A3 that is the most rear end side in the posterior region 91c may be, for example, 30% by volume or more and 50% by volume. More preferably, the porosity in the area A3 may be 30% by volume or more and 45% by volume or less, or, 30% by volume or more and 40% by volume or less.

A porosity in the electrode presence region 91b of the inner layer 91 may be, for example, 40% by volume or more and 80% by volume or less. This is based on the premise that the porosity in the electrode presence region 91b is higher than the porosity in the posterior region 91c of the inner layer 91. When the porosity in the electrode presence region 91b is within such a range, it is possible to maintain high heat insulation effect of the inner layer 91. Here, the porosity in the electrode presence region 91b may be an average porosity in the electrode presence region 91b. Alternatively, a porosity at a predetermined position (for example, a center position) in the longitudinal direction of the electrode presence region 91b may be used as a porosity in the electrode presence region 91b. The porosity in the electrode presence region 91b of the inner layer 91 may be, for example, 40% by volume or more and 70% by volume or less, or, 40% by volume or more and 60% by volume or less.

The porosity in the posterior region 91c of the inner layer 91 may be lower than the porosity in the electrode presence region 91b of the inner layer 91 by 5% by volume or more. When a difference in the porosity is within such a range, it is possible to maintain higher heat insulation effect of the inner layer 91, while high structural strength of the inner layer 91 is maintained. Further, the porosity in the posterior region 91c of the inner layer 91 may be lower than the porosity in the electrode presence region 91b of the inner layer 91, for example, by 6% by volume or more.

A porosity in the anterior region 91a of the inner layer 91 is not particularly limited, and may be, for example, 30% by volume or more and 80% by volume or less. The porosity in the anterior region 91a of the inner layer 91 may be equivalent to the porosity in the electrode presence region 91b of the inner layer 91. The porosity in the anterior region 91a may be higher or lower than the porosity in the electrode presence region 91b of the inner layer 91. The porosity in the anterior region 91a may be higher than the porosity in the posterior region 91c. Further, a porosity in an area that covers the front end surface 102e of the element body 102 in the inner layer 91 is not particularly limited, and may be, for example, equivalent to the porosity in the anterior region 91a.

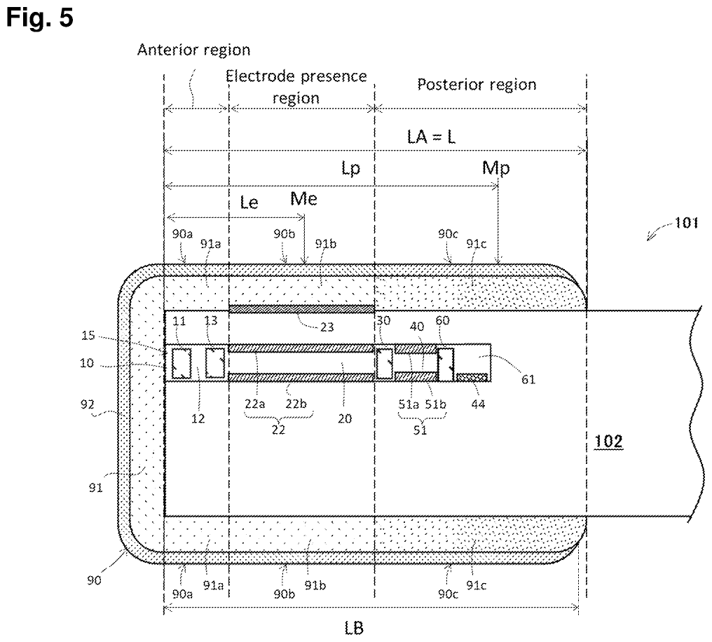

Determination method of the porosity will be described. FIG. 5 is a schematic sectional view of the same section as shown in FIG. 3, which shows the structure of the porous protective layer 90 (the inner layer 91 and the outer layer 92). In FIG. 5, as in the case of FIG. 3, the components inside the element body 102 are not shown except for the measurement-object gas flow cavity 15, the intracavity electrodes and the extracavity electrode.

A porosity at a position Mp of a predetermined length Lp in the longitudinal direction from the front end of the element body 102 in the posterior region 91c of the inner layer 91 may be used as a porosity in the posterior region 91c of the inner layer 91. In FIG. 5, the position Mp of the predetermined length Lp is a position in the posterior region 91c slightly rear from the measurement-object gas flow cavity 15. A porosity at a position Me of a predetermined length Le in the longitudinal direction from the front end of the element body 102 may be used as a porosity in the electrode presence region 91b. In FIG. 5, the position Me is a center position in the longitudinal direction in the electrode presence region 91b.

The porosity is determined in the following manner using an image (SEM image) obtained by observation with a scanning electron microscope (SEM). As in the case of determination of the thickness described above, the magnification of the SEM is set to 80 times, and the SEM image of section of the inner layer 91 of the porous protective layer 90 is obtained. In detail, the SEM image is obtained, which is imaged so that the position Mp of the predetermined length Lp in the longitudinal direction from the front end of the element body 102 in the posterior region 91c of the inner layer 91 is centered. The SEM image shows the inner layer 91 in an area of 500 μm (height)×1500 μm (width). Then, the obtained SEM image is binarized using “Otsu's method” (also referred to as discriminant analysis method). In the binarized image, alumina is shown in white and pores are shown in black. In the binarized image, area of alumina portions (white) and area of pore portions (black) are obtained. The ratio of the area of the pore portions to total area (total of the area of the alumina portions and the area of the pore portions) is calculated, and the calculated ratio may be used as a porosity in the posterior region 91c of the inner layer 91.

Further, the SEM image is obtained, which is imaged so that the position Me of the predetermined length Le in the longitudinal direction from the front end of the element body 102 in the electrode presence region 91b of the inner layer 91 is centered. The ratio of the area of the pore portions to total area (total of the area of the alumina portions and the area of the pore portions) is calculated in the obtained SEM image as in the case of the posterior region 91c described above, and the calculated ratio may be used as a porosity in the electrode presence region 91b of the inner layer 91.

As a porosity in the posterior region 91c of the inner layer 91, for example, a porosity at a center position of the posterior region 91c may be used. Alternatively, a porosity at the position of the rear end of the measurement-object gas flow cavity 15 may be used. Alternatively, a porosity at a center position between the rear end of the measurement-object gas flow cavity 15 and the rear end of the inner layer 91 may be used. Alternatively, based on the length LA in the longitudinal direction of the inner layer 91, a porosity at about ⅔, about ¾, or about ⅘ of the length LA from the front end of the element body 102 may be used as a porosity in the posterior region 91c of the inner layer 91. Further, an average value of porosities calculated at multiple positions may be used as a porosity in the posterior region 91c of the inner layer 91.

As a porosity in the electrode presence region 91b of the inner layer 91, for example, as described above, a porosity at a center position of the electrode presence region 91b may be used. Alternatively, a porosity at a position with higher temperature in the electrode presence region 91b may be used. Alternatively, based on the length LA in the longitudinal direction of the inner layer 91, a porosity at about ⅓, about ¼, or about ⅖ of the length LA from the front end of the element body 102 may be used as a porosity in the electrode presence region 91b of the inner layer 91. Further, an average value of porosities calculated at multiple positions may be used as a porosity in the electrode presence region 91b of the inner layer 91.

A porosity of the outer layer 92 is lower than a porosity at any position in the inner layer 91 as described above. The porosity of the outer layer 92 may be, for example, about 10% by volume or more and 35% by volume or less. This is based on the premise that the porosity of the outer layer 92 is lower than a porosity at any position in the electrode presence region 91b and the posterior region 91c of the inner layer 91. The porosity of the outer layer 92 may be also determined using the above-described determination method of the porosity. The outer layer 92 is considered to have substantially the same porosity regardless of observation area. Therefore, the porosity determined using one sectional image may be used as the porosity of the outer layer 92.

The sensor element 101 and the gas sensor 100 including the sensor element 101 for detecting NOx concentration in a measurement-object gas have been described above as examples of the embodiment according to the present invention, but the present invention is not limited thereto. The present invention may include a sensor element having any structure as long as the object of the present invention can be achieved, that is, the water resistance of sensor element is improved while the adhesion strength between the element body and the protective layer is maintained.

In the gas sensor 100 of the above embodiment, as shown in FIG. 4, in the inner layer 91 of the porous protective layer 90, an example in which the porosity decreases stepwise in the area A1, the area A2, and the area A3 in this order from the front end of the element body 102 (the base part 103) rearward in the longitudinal direction is shown, but the inner layer 91 is not limited thereto. The inner layer 91 can have any structure as long as the porosity in the posterior region 91c of the inner layer 91 is lower than the porosity in the electrode presence region 91b.

For example, in the longitudinal direction of the element body 102, the inner layer 91 may have different porosities in an area of front end side and an area of rear end side with the rear end of the electrode presence region 91b, that is, the front end of the posterior region 91c as a boundary (the porosity in the area of the front end side>the porosity in the area of the rear end side).

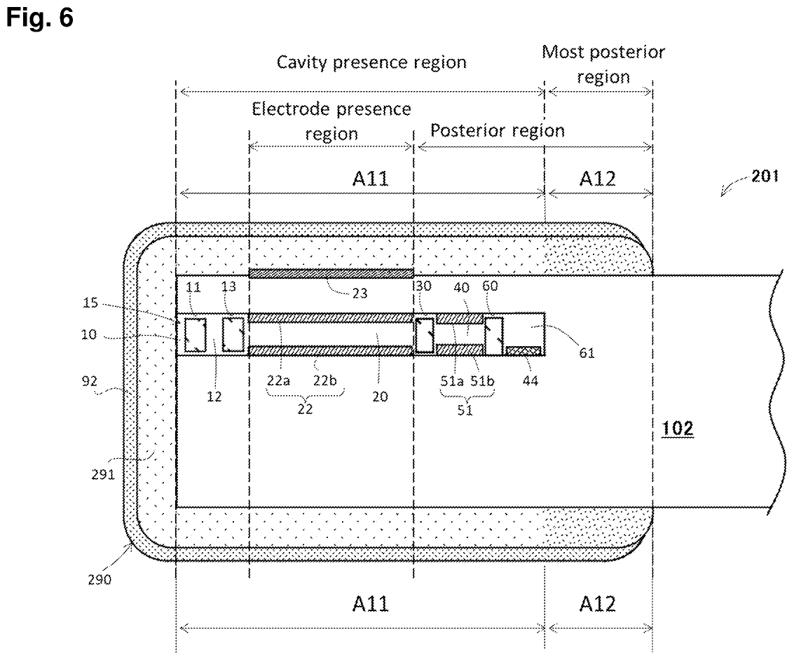

Further, FIG. 6 shows another example of the porous protective layer. FIG. 6 is a schematic sectional view of the same section as shown in FIG. 3 to FIG. 5, which shows the structure of a porous protective layer 290 (an inner layer 291 and an outer layer 92) of a sensor element 201 of another example having a porous protective layer with a different structure. In FIG. 6, as in the case of FIG. 3, the components inside the element body 102 are not shown except for the measurement-object gas flow cavity 15, the intracavity electrodes and the extracavity electrode. In FIG. 6, the same member as in FIG. 3 to FIG. 4 is denoted by the same sign. The inner layer 291 of the porous protective layer 290 may have different porosities in an area A11 of front end side and an area A12 of rear end side with the rear end of the measurement-object gas flow cavity 15 as a boundary (the porosity in the area A11 of the front end side>the porosity in the area A12 of the rear end side). That is, the inner layer 291 (the porous protective layer 290) is so configured that the area A11 having a high porosity is in a cavity presence region in which the measurement-object gas flow cavity 15 exists and the area A12 having a low porosity is in a most posterior region following to the cavity presence region. In the sensor element 201, a porosity in the most posterior region in which the measurement-object gas flow cavity 15 does not exist in the posterior region following to the rear of the electrode presence region is lower than a porosity in the electrode presence region.

Further, for example, when the inner layer 91 is divided into three equal portions, an anterior portion, a middle portion, and a posterior portion based on the length LA of the inner layer 91 in the longitudinal direction from the front end of the element body 102, a porosity in the posterior portion may be lower than a porosity in the middle portion. In this case, a porosity in the anterior portion may be equivalent to the porosity in the middle portion, or may be higher or lower than the porosity in the middle portion. Further, the porosity in the anterior portion may be higher than the porosity in the posterior portion.

Further, a porosity of the inner layer 91 may be stepwise or continuously decreased in the longitudinal direction of the element body 102 (the base part 103) from the one end (the front end) in the longitudinal direction of the element body 102 (the base part 103) toward the other end (the rear end). In the inner layer 91 in the above embodiment, the porosity is decreased in three steps, but the porosity may be stepwise decreased (substantially stepwise decreased) in four steps or more. The porosity may be continuously decreased (substantially continuously decreased).

In the gas sensor 100 of the above embodiment, the porous protective layer 90 is constituted from the inner layer 91 and the outer layer 92, but the porous protective layer 90 is not limited thereto. The porous protective layer 90 may have one or more intermediate layers between the inner layer 91 and the outer layer 92.

In the gas sensor 100 of the above embodiment, the outer pump electrode 23 is positioned on the surface of the element body 102 and the inner layer 91 of the porous protective layer 90 is formed in contact with the outer pump electrode 23 on the surface of the element body 102. However, the present invention is not limited to this. For example, the element body 102 may be provided with a principal surface protective layer on the two principal surfaces (the pump surface 102a and the heater surface 102b). The principal surface protective layer is provided for the purpose of preventing foreign matter and poisoning substances from attaching to the principal surfaces (the pump surface 102a and the heater surface 102b) of the element body 102 and the outer pump electrode 23 on the pump surface 102a. The principal surface protective layer may be, for example, a porous layer formed of ceramics such as alumina. A porosity of the principal surface protective layer may be, for example, about 20% by volume or more and 40% by volume or less. A thickness of the principal surface protective layer may be, for example, about 5 μm to 30 μm.

Further, for example, the element body 102 may be further provided with a ground layer for forming the inner layer 91. The ground layer is provided for the purpose of further improving the adhesion between the element body 102 and the inner layer 91. When the ground layer is provided, the ground layer may be formed on at least the two principal surfaces (the pump surface 102a and the heater surface 102b) of the element body 102. The ground layer may be, for example, a porous layer formed of ceramics such as alumina. A porosity of the ground layer may be, for example, about 40% by volume or more. The porosity of the ground layer may be, for example, about 40% by volume or more and 60% by volume or less. A thickness of the ground layer may be, for example, about 20 μm to 60 μm.

In the above embodiment, the gas sensor 100 detects the NOx concentration in a measurement-object gas. However, the target gas to be measured is not limited to NOx. The sensor element of the gas sensor 100 may have a structure using the oxygen-ion-conductive solid electrolyte. For example, the target gas to be measured may be oxygen O₂ or an oxide gas other than NOx (e.g., carbon dioxide CO₂, water H₂O). Alternatively, the target gas to be measured may be a non-oxide gas such as ammonia NH₃.

In the gas sensor 100 of the above embodiment, as shown in FIG. 2, the sensor element 101 has a structure in which three internal cavities, the first internal cavity 20, the second internal cavity 40, and the third internal cavity 61 are provided and the inner main pump electrode 22, the auxiliary pump electrode 51, and the measurement electrode 44 are respectively disposed in these internal cavities. However, the structure of the sensor element 101 is not limited thereto. For example, the sensor element 101 may have a structure in which two internal cavities, the first internal cavity 20 and the second internal cavity 40 are provided, the inner main pump electrode 22 is disposed in the first internal cavity 20, and the auxiliary pump electrode 51 and the measurement electrode 44 are disposed in the second internal cavity 40. In this case, for example, a porous protective layer covering the measurement electrode 44 may be formed as a diffusion-rate limiting part between the auxiliary pump electrode 51 and the measurement electrode 44. Further, the number of the internal cavities may be one, or may be four or more.

In the gas sensor 100 of the above embodiment, the outer pump electrode 23 has three functions as an outer main pump electrode in the main pump cell 21, an outer auxiliary pump electrode in the auxiliary pump cell 50, and an outer measurement electrode in the measurement pump cell 41. However, the outer pump electrode 23 is not limited thereto. For example, the outer main pump electrode, the outer auxiliary pump electrode, and the outer measurement electrode may be formed as different electrodes. For example, any one or more of the outer main pump electrode, the outer auxiliary pump electrode, and the outer measurement electrode may be provided on the outer surface of the base part 103 separately from the outer pump electrode 23 so as to be in contact with a measurement-object gas. In this case, the electrode presence region means, in the longitudinal direction of the element body 102, a region from a front end of an electrode disposed the most front end side to a rear end of an electrode disposed the most rear end side among the outer main pump electrode, the outer auxiliary pump electrode, and the outer measurement electrode. In the longitudinal direction of the element body 102, the rear end of the electrode presence region is usually positioned on the front end side of the rear end of the measurement-object gas flow cavity 15, or positioned roughly at the rear end of the measurement-object gas flow cavity 15.

Each of the components of the element body 102 other than the above-described components, such as the measurement-object gas flow cavity 15 and the electrodes, can also be variously embodied in accordance with the kind of target gas to be measured, the intended use or use environment of the gas sensor and the like.

### [Production Method of Sensor Element]

Hereinbelow, an example of a production method of such a sensor element as described above will be described. In the production method of the sensor element 101, the element body 102 is first produced, and then the porous protective layer 90 is formed on the element body 102 to produce the sensor element 101.

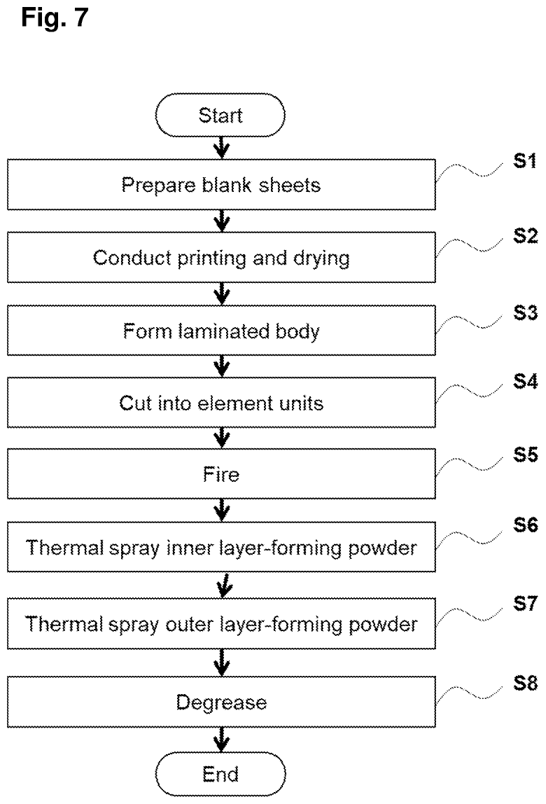

Hereinafter, description is made while taking the case of manufacturing the sensor element 101 composed of six layers shown in FIG. 2 as an example. FIG. 7 is a flowchart showing an example of the production method of the sensor element.

### (Production of Element Body)

First, a method for producing the element body 102 will be described. Six blank sheets are prepared (step S1). The blank sheets are green sheets containing an oxygen-ion-conductive solid electrolyte such as zirconia (ZrO₂) as a ceramic component. For manufacturing of the green sheets, a known molding method can be used. In each of the six green sheets, sheet holes or the like for use in positioning at the time of printing or stacking are formed in advance by a known method such as a punching process with a punching apparatus. These are referred to as blank sheets. In the blank sheet for use as the spacer layer 5, penetrating parts such as internal cavities are also formed in the same manner. Also in the remaining layers, necessary penetrating parts are formed in advance. The six blank sheets may all have the same thickness, or the thickness differs depending on the layer to be formed.

The blank sheets for use as six layers, namely, the first substrate layer 1, the second substrate layer 2, the third substrate layer 3, the first solid electrolyte layer 4, the spacer layer 5, and the second solid electrolyte layer 6 are subjected to printing of various patterns required for respective layers and drying treatment (step S2). For printing of a pattern, a known screen printing technique can be used. Also as the drying treatment, a known drying means can be used.

After completing the printing and drying of diverse patterns for each of the six blank sheets by repeating these steps, contact bonding treatment of stacking the six printed blank sheets in a predetermined order while positioning with the sheet holes and the like, and contact bonding at a predetermined temperature and pressure condition is conducted to form a laminated body (step S3). The contact bonding treatment is conducted by heating and pressurizing with a known laminator such as a hydraulic press. While the temperature, the pressure and the time of heating and pressurizing depend on the laminator being used, they may be appropriately determined to achieve excellent lamination.

The obtained laminated body includes a plurality of element bodies 102. The laminated body is cut into units of the element body 102 (step S4). The cut laminated body is fired at a predetermined firing temperature to obtain the element body 102 (step S5). The firing temperature may be such a temperature that the solid electrolyte forming the base part 103 of the sensor element 101 is sintered to become a dense product, and electrodes or the like maintains desired porosity. The firing is conducted, for example, at a firing temperature of about 1300 to 1500° C.

### (Production of Protective Layer)

Next, a method for forming the porous protective layer 90 (the inner layer 91 and the outer layer 92) on the element body 102 will be described. In this embodiment, the porous protective layer 90 is formed by plasma spraying.

First, a sprayed coating that should serve as the inner layer 91 is formed. That is, an inner layer-forming powder prepared in advance is thermally splayed onto a predetermined area on the element body 102 (step S6). Next, an outer layer-forming powder prepared in advance is thermally splayed onto a predetermined area on the sprayed coating that should serve as the inner layer 91 of the element body 102 (step S7). Then, degreasing is conducted (step S8) to form the porous protective layer 90 (the inner layer 91 and the outer layer 92).

The inner layer-forming powder includes a raw material powder (in this embodiment, an alumina powder) composed of the material of the inner layer 91 and having a predetermined particle size distribution, and a pore forming material. Examples of the pore forming material that can be used include a xanthine derivative such as theobromine, an organic resin material such as an acrylic resin, and an inorganic material such as carbon. The inner layer-forming powder contains the alumina powder and an organic pore forming material at a ratio corresponding to a porosity of the inner layer 91 to be formed. In this embodiment, inner layer-forming powders corresponding to respective porosities in the area A1, the area A2, and the area A3 of the inner layer 91 are prepared.

The inner layer-forming powder is thermally splayed onto an area where the inner layer 91 is to be formed on the surface of the element body 102 to form a sprayed coating (step S6). For thermal spraying, a known plasma spraying technique can be used. Specifically, a sprayed coating corresponding to the porosity of the area A1 is formed on an area where the area A1 is to be formed in the area where the inner layer 91 is to be formed. A sprayed coating corresponding to the porosity of the area A2 is formed on an area where the area A2 is to be formed in the area where the inner layer 91 is to be formed. A sprayed coating corresponding to the porosity of the area A3 is formed on an area where the area A3 is to be formed in the area where the inner layer 91 is to be formed. It is to be noted that the order of forming these sprayed coatings may be appropriately determined. The sprayed coatings may be formed simultaneously on two or more areas.

Then, the outer layer 92 is formed. The outer layer-forming powder prepared in advance is thermally splayed onto a predetermined area on the sprayed coating that should serve as the inner layer 91 on the element body 102 (step S7) to form the outer layer 92.

The outer layer-forming powder includes a raw material powder (in this embodiment, an alumina powder) composed of the material of the outer layer 92 and having a predetermined particle size distribution. Unlike the case of the inner layer-forming powder, the outer layer-forming powder does not usually include the pore forming material.

The outer layer-forming powder is thermally splayed onto an area where the outer layer 92 is to be formed on the surface of the sprayed coating that should serve as the inner layer 91 on the element body 102 to form a sprayed coating (i.e., the outer layer 92) (step S7). For thermal spraying, a known plasma spraying technique can be used.

Finally, the formed sprayed coating that should serve as the inner layer 91 is subjected to heat treatment to be degreased (step 8). Degreasing makes the pore forming material in the sprayed coating disappear to form the inner layer 91 comprising a porous material. The step of degreasing is performed at a predetermined degreasing temperature. The degreasing temperature is not particularly limited as long as all pore forming material components in the sprayed coating of the inner layer 91 can disappear and the porous structure of the inner layer 91 can be maintained. The degreasing temperature may be lower than the firing temperature of the element body 102. For example, the sprayed coating is degreased at a degreasing temperature of about 400 to 900° C. In the step of degreasing, the sprayed coating of the outer layer 92 that does not contain the pore forming material is to be subjected to heat treatment at the same time.

In the above production method, thermal spraying of the inner layer-forming powder (step S6), thermal spraying of the outer layer-forming powder (step S7), and decreasing (step S8) are conducted in this order. However, thermal spraying of the inner layer-forming powder (step S6), and decreasing (step S8) may be conducted, and then thermal spraying of the outer layer-forming powder (step S7) may be conducted.

In the above production method, the inner layer 91 and the outer layer 92 are respectively formed by plasma spraying, but the production method is not limited to this. The inner layer 91 and the outer layer 92 may be respectively formed using other methods such as screen printing, dipping, and gel casting. Further, the inner layer 91 and the outer layer 92 may be formed using different methods from each other.

The obtained sensor element 101 is housed in a predetermined housing and incorporated in the gas sensor 100 in such a manner that the front end portion of the sensor element 101 comes into contact with a measurement-object gas and the rear end portion of the sensor element 101 comes into contact with a reference gas.

### EXAMPLES

Hereinafter, the case of actually manufacturing a sensor element and conducting a test is described as Examples. The present invention is not limited to the following Examples.

### 1. Production of Examples 1 to 3 and Comparative Example 1

The sensor elements of Examples 1 to 3 were produced in accordance with the above-described production method of the sensor element 101. Specifically, an element body 102 was produced which had a longitudinal length of 67.5 mm, a horizontal width of 4.25 mm, and a vertical thickness of 1.45 mm. The outer pump electrode 23 was disposed with the length of 3.1 mm in the longitudinal direction from a position of 1.6 mm in the longitudinal direction from the front end of the element body 102 toward the rear. Then, a porous protective layer 90 (an inner layer 91 and an outer layer 92) were formed by plasma spraying to produce the sensor element 101.

In all of the sensor elements of Examples 1 to 3, the porosity of the inner layer 91 was stepwise decreased in the longitudinal direction from the front end of the element body 102. In all of the sensor elements of Examples 1 to 3, the length of the inner layer 91 in the longitudinal direction from the front end of the element body 102 was set to 10 mm and the thickness of the inner layer 91 was set to 500 μm. In all of the sensor elements of Examples 1 to 3, the length of the outer layer 92 in the longitudinal direction from the front end of the element body 102 was set to 9 mm and the thickness of the outer layer 92 was set to 200 μm. The porosity of the outer layer 92 was 25%.

A sensor element of Comparative Example 1 was produced in the same manner as in Examples 1 to 3 except that the porosity of the inner layer 91 was stepwise increased in the longitudinal direction from the front end of the element body 102. In the sensor element of Comparative Example 1, the length LA of the inner layer 91 in the longitudinal direction from the front end of the element body 102 was set to 10 mm and the thickness of the inner layer 91 was set to 500 μm.

Referring to FIG. 5, in each of the sensor elements of Examples 1 to 3 and Comparative Example 1, a porosity in the electrode presence region 91b was determined from the SEM image at the position Me of 4 mm (Le=4 mm) in the longitudinal direction from the front end of the element body 102. That is, the porosity in the electrode presence region 91b was determined from the SEM image at the position Me of ⅖ of the length LA (Le=2LA/5) in the longitudinal direction of the inner layer 91 from the front end of the element body 102. Further, in each of the sensor elements of Examples 1 to 3 and Comparative Example 1, a porosity in the posterior region 91c was determined from the SEM image at the position Mp of 8 mm (Lp=8 mm) in the longitudinal direction from the front end of the element body 102. That is, the porosity in the posterior region 91c was determined from the SEM image at the position Mp of ⅘ of the length LA (Lp=4LA/5) in the longitudinal direction of the inner layer 91 from the front end of the element body 102. The porosity in the electrode presence region 91b and the porosity in the posterior region 91c were respectively obtained using the above-described determination method of the porosity. Further, a porosity difference [=(the porosity in the electrode presence region 91b)−(the porosity in the posterior region 91c)] was calculated. A positive porosity difference indicates that the porosity in the posterior region 91c was lower than the porosity in the electrode presence region 91b. Hereinafter, the unit (%) of the porosity means % by volume.

In the sensor element of Example 1, the porosity in the electrode presence region 91b was 55.7%, the porosity in the posterior region 91c was 54.1%, and the porosity difference was 1.6%.

In the sensor element of Example 2, the porosity in the electrode presence region 91b was 42.7%, the porosity in the posterior region 91c was 37.1%, and the porosity difference was 5.6%.

In the sensor element of Example 3, the porosity in the electrode presence region 91b was 56%, the porosity in the posterior region 91c was 37.8%, and the porosity difference was 18.2%.

In the sensor element of Comparative Example 1, the porosity in the electrode presence region 91b was 45.7%, the porosity in the posterior region 91c was 56.1%, and the porosity difference was minus (−) 10.4%.

### 2. Evaluation of Water Resistance

The sensor elements 101 of Examples 1 to 3 and Comparative Example 1 were subjected to evaluation of the performance of the porous protective layer 90 (water resistance of the sensor element 101). Specifically, initially, the heater 72 was energized, the temperature was set at 800° C., and the sensor element 101 was heated. In this state, the main pump cell 21, the auxiliary pump cell 50, the oxygen-partial-pressure detection sensor cell 80 for main pump control, the oxygen-partial-pressure detection sensor cell 81 for auxiliary pump control, and the like were actuated in an air atmosphere and the oxygen concentration in the first internal cavity 20 was controlled so as to be maintained at a predetermined constant value. Then, after waiting stabilization of the pump current Ip0, water was dropped onto a substantially center position in the longitudinal direction of the electrode presence region in the porous protective layer 90 on the pump surface 102a. Then, presence or absence of a crack in the sensor element 101 was determined on the basis of whether or not the pump current Ip0 increased by 5% or more. If cracking occurs in the sensor element 101 because of thermal shock due to a water droplet, oxygen passes through the cracked portion and flows into the first internal cavity 20 easily, so that the value of the pump current Ip0 increases. Therefore, in the case where the pump current Ip0 was increased by 5% or more, it was judged that cracking occurred in the sensor element 101 because of the water droplet.

Further, a plurality of tests was performed by gradually increasing the amount of water droplets to 60 μL to determine the amount of water droplets at the time when the pump current Ip0 increased by 5% or more (when cracking was suspected to occur in the sensor element 101). Twelve sensor elements 101 of each of Examples 1 to 3 and Comparative Example 1 were prepared, and the average of the amounts of water droplets for the twelve sensor elements 101 was determined for each of Examples 1 to 3 and Comparative Example 1. The average of the amounts of water droplets was used as an index of the water resistance. The higher average of the amounts of water droplets indicates the higher water resistance.

### 3. Evaluation of Pull-Out Strength

The sensor elements 101 of Examples 1 to 3 and Comparative Example 1 were subjected to evaluation of the pull-out strength of the porous protective layer 90 from the element body 102, as an index of the structural strength of the porous protective layer 90. The pull-out strength was measured in the following manner. The porous protective layer 90 of the sensor element 101 was fixed by a test tool. Specifically, a test tool with a penetration hole of approximately the same size as a cross section perpendicular to the longitudinal direction of the element body 102 of the sensor element 101 was prepared. The sensor element 101 was passed through the penetration hole of the test tool so that the porous protective layer 90 was caught in the penetration hole of the test tool. In this state, the test tool and the rear end of the sensor element 101 were pulled by a tensile testing machine to measure a stress-strain curve (SS curve). As the tensile testing machine, an autograph testing machine (AGS-5kNx; Shimadzu Corporation) was used. A maximum stress required to deform 1 mm was calculated from the obtained stress-strain curve (SS curve). Twelve sensor elements 101 of each of Examples 1 to 3 and Comparative Example 1 were prepared, and the average of the maximum stress for the twelve sensor elements 101 was determined for each of Examples 1 to 3 and Comparative Example 1. The average of the maximum stress was used as the pull-out strength of the porous protective layer 90.

The results of the water resistance and the pull-out strength are shown in Table 1.

TABLE 1

| | Porosity in | | | | |
|---|---|---|---|---|---|
| | electrode | Porosity in | Porosity | Water resistance | |
| | presence | posterior | differ- | Average amounts | Pull-out |
| | region 91b | region 91c | ence | of water droplets | strength |
| | (%) | (%) | (%) | (μL) | (N) |
| Example 1 | 55.7 | 54.1 | 1.6 | 26.4 | 117 |
| Example 2 | 42.7 | 37.1 | 5.6 | 18.6 | 314 |
| Example 3 | 56.0 | 37.8 | 18.2 | 29.0 | 251 |
| Compara- | 45.7 | 56.1 | −10.4 | 13.8 | 129 |
| tive | | | | | |
| Example 1 | | | | | |

As shown in Table 1, all of Examples 1 to 3 were confirmed to be able to maintain both of the water resistance and the pull-out strength at a level equivalent to or higher than that of Comparative Example 1. Further, in Examples 1 to 2, it was confirmed that the pull-out strength was significantly improved while the high water resistance was maintained.

As has been described above, according to the present invention, the heat insulating effect of the electrode presence region 91b can be highly maintained while the adhesion strength between the element body 102 and the inner layer 91 is highly maintained by the posterior region 91b of the inner layer 91. Therefore, it is possible to provide the sensor element that has high water resistance while the adhesion strength between the element body 102 and the porous protective layer 90 is maintained.

### EXPLANATION OF REFERENCE SIGNS IN THE DRAWINGS

1: first substrate layer; 2: second substrate layer; 3: third substrate layer; 4: first solid electrolyte layer; 5: spacer layer; 6: second solid electrolyte layer; 10: gas inlet; 11: first diffusion-rate limiting part; 12: buffer space; 13: second diffusion-rate limiting part; 15: measurement-object gas flow cavity; 20: first internal cavity; 21: main pump cell; 22: inner main pump electrode; 22a: ceiling electrode portion (of the inner main pump electrode); 22b: bottom electrode portion (of the inner main pump electrode); 23: outer pump electrode; 24: variable power supply (of the main pump cell); 30: third diffusion-rate limiting part; 40: second internal cavity; 41: measurement pump cell; 42: reference electrode; 43: reference gas introduction space; 44: measurement electrode; 46: variable power supply (of the measurement pump cell); 48: air introduction layer; 50: auxiliary pump cell; 51: auxiliary pump electrode; 51a: ceiling electrode portion (of the auxiliary pump electrode); 51b: bottom electrode portion (of the auxiliary pump electrode); 52: variable power supply (of the auxiliary pump cell); 60: fourth diffusion-rate limiting part; 61: third internal cavity; 70: heater part; 71: heater electrode; 72: heater; 73: through hole; 74: heater insulating layer; 75: pressure relief vent; 76: heater lead; 80: oxygen-partial-pressure detection sensor cell for main pump control; 81: oxygen-partial-pressure detection sensor cell for auxiliary pump control; 82: oxygen-partial-pressure detection sensor cell for measurement pump control; 83: sensor cell; 90, 290: porous protective layer; 91, 291: inner layer; 92: outer layer; 100: gas sensor; 101, 102: sensor element; 102: element body; and 103: base part.

What is claimed is:

1. A sensor element for detecting a target gas to be measured in a measurement-object gas, the sensor element comprising:
an element body that includes a base part in an elongated plate shape, including an oxygen-ion-conductive solid electrolyte layer, and a measurement-object gas flow cavity formed on a side of one end in a longitudinal direction of the base part; and
a porous protective layer that is formed from the one end in the longitudinal direction of the base part and covers a surface of a predetermined length in the longitudinal direction of the element body, wherein
the element body comprises: an intracavity electrode disposed in the measurement-object gas flow cavity; and an extracavity electrode that has a predetermined length in the longitudinal direction of the base part, is disposed on one principal surface of two principal surfaces of the element body, and corresponds to the intracavity electrode; and
the protective layer comprises an inner layer covering the element body and an outer layer positioned outside the inner layer; and has an electrode presence region in which the extracavity electrode exists and a posterior region following to the electrode presence region in the longitudinal direction of the base part; and wherein
a porosity in the posterior region of the inner layer is lower than a porosity in the electrode presence region of the inner layer, and
a porosity of the outer layer is lower than the porosity in the posterior region of the inner layer.

2. The sensor element according to claim 1, wherein the posterior region of the protective layer extends in the longitudinal direction of the base part to a position farther from the one end in the longitudinal direction of the base part than the measurement-object gas flow cavity.

3. The sensor element according to claim 2, wherein, in the longitudinal direction of the base part, a porosity in a region farther from the one end in the longitudinal direction of the base part than the measurement-object gas flow cavity in the posterior region of the protective layer is lower than the porosity in the electrode presence region of the inner layer.

4. The sensor element according to claim 1, wherein the porosity in the posterior region of the inner layer is 30% by volume or more and 50% by volume or less.

5. The sensor element according to claim 1, wherein the porosity in the electrode presence region of the inner layer is 40% by volume or more and 80% by volume or less, provided that the porosity in the electrode presence region of the inner layer is higher than the porosity in the posterior region of the inner layer.

6. The sensor element according to claim 1, wherein the porosity in the posterior region of the inner layer is lower than the porosity in the electrode presence region of the inner layer by 5% by volume or more.

7. The sensor element according to claim 1, wherein the posterior region of the protective layer extends in the longitudinal direction of the base part to a position farther from the one end in the longitudinal direction of the base part than the measurement-object gas flow cavity, and
the porosity in the posterior region of the inner layer is lower than the porosity in the electrode presence region of the inner layer by 5% by volume or more.

8. The sensor element according to claim 1, wherein a porosity of the inner layer is stepwise or continuously decreased in the longitudinal direction of the base part from the one end in the longitudinal direction of the base part.
